(19) United States
(12) Patent Application Publication
(10) Pub. No.: US 2005/0174974 A1
(43) Pub. Date: Aug. 11, 2005

(54) System and method for roaming in data -and communication- networks

(76) Inventors: Artur H. Sonntag, Potsdam (DE); Djamshid Tavangarian, Rostock (DE); Magnus H. Bergs, Reykjavik (IS)

Correspondence Address: Norris, McLaughlin & Marcus P.A., 30th Floor, 220 East 42nd Street, New York, NY, 10017, US

(21) Appl. No.: 10/920,645

(22) Filed: Aug. 18, 2004

(30) Foreign Application Priority Data
Aug. 19, 2003 (DE) 103 39 041.3

(51) Int. Cl. H04Q 7/24

(52) U.S. Cl. 370/338

(57) ABSTRACT

The present invention is directed to a system and a method for roaming in data and/or communication networks, and to a corresponding computer program and a corresponding computer-readable storage medium, which can be used, in particular, to enable users in rapidly moving vehicles to use the Internet. A system for roaming in data and/or communication networks is proposed for clients moving at a high speed, wherein access points (AP) are arranged along the travel route of the clients for providing wireless access to data and/or communication networks, for example the Internet, wherein at least one AP is connected directly via a communication link with the data and/or communication network, and wherein APs without a direct connection to the data and/or communication network are connected to APs that have a direct connection to the data and/or communication network.

The present invention is directed to a system and a method for roaming in access regions of data and/or communication networks for use With a client moving at high speed, and a corresponding computer program and a corresponding computer-readable storage medium, which can be used, in particular, to enable users in fast moving vehicles to use the Internet.

Wireless LAN based on the IEEE 802.11 standard [3] has over the past years developed into one of the most widely used business areas for communication technologies [1]. In addition to being used with desktop computers and notebooks, WLAN is already supported by a large number of devices, for example PDAs or tablet PCs, as a connection tool to wireless networks. The majority of modern wireless networks operating according to the WLAN standard use the extended IEEE 802.11b [4] standard with a maximum available bandwidth of 11 Mbps and operating in the unlicensed 2.4 GHz ISM (Industrial, Science and Medical) frequency band. In the near future, the promising extensions 802.11g in the 2.4 GHz frequency band and 802.11a in the 5 GHz frequency band with higher overall data rates of 54 Mbps will be available in addition to the actual Version 802.11b technology.

The description of the invention uses terminology from the field of wireless communication, which needs to be defined for a better understanding. A brief explanation of the various important terms will therefore be provided below:

Client, Server, and User:

In the field of wireless communication, the terms client and user are used synonymously for the terminal using the service. Conversely, devices defined as servers provide the services. It will be understood that both clients and servers use the WLAN for communication. It should be noted that the terms client and server do not make any statement about their mobility.

Ad-Hoc Mode, Infrastructure Mode, Hotspot, and Access Point:

In the IEEE 802.11 standard, a difference is made between two different network topologies. In one technology, the so-called ad-hoc mode, clients establish a spontaneous communication network with one another exclusively by direct connections. Disadvantages of the first technology are mainly the small number of clients communicating with each other and/or the limited scalability of the network due to the point-to-point connections between the clients. In addition, communication with so-called Hidden Stations is not possible. Hidden stations refer to spaced-apart stations that cannot communicate with each other due to the topology, even if two clients intend to communicate with each other, because the stations are too far apart to reach each other, although a third intermediate station located in between would be able to assume a relay or coordinating function.

To eliminate the aforedescribed disadvantages, the Infrastructure Mode was defined. This mode uses a special server in the center of a star-topology for managing the communication processes. Stated differently, there is no direct communication between the individual clients. Each access point defines a so-called WLAN cell by the physical extent of the channel allocated to the access point. Such cells can be combined with each other to cover an entire area or region. The advantage of this combination is the possibility to seamlessly switch connections from one cell to a neighboring cell. The data of the client are thereby transmitted from the access point of the current cell to that of the new cell by using a special protocol (frequently, the Inter Access Point Protocol—IAAP is used). To connect distant wireless cells with each other, or to bridge greater distances, the IEEE standard 802.11 defines additional bridging functionalities. On one hand, point-to-point connections can be set up. However, the standard also defines one-to-many point connections.

Due to the rapid expansion of wireless WLAN networks in public areas, such an accumulation of WLAN cells is now referred to as hotspot. In principle, these represent not necessarily contiguous areas where a wireless network according to IEEE 802.11 is available in Infrastructure Mode. The number of hotspots is thereby immaterial.

Mobility:

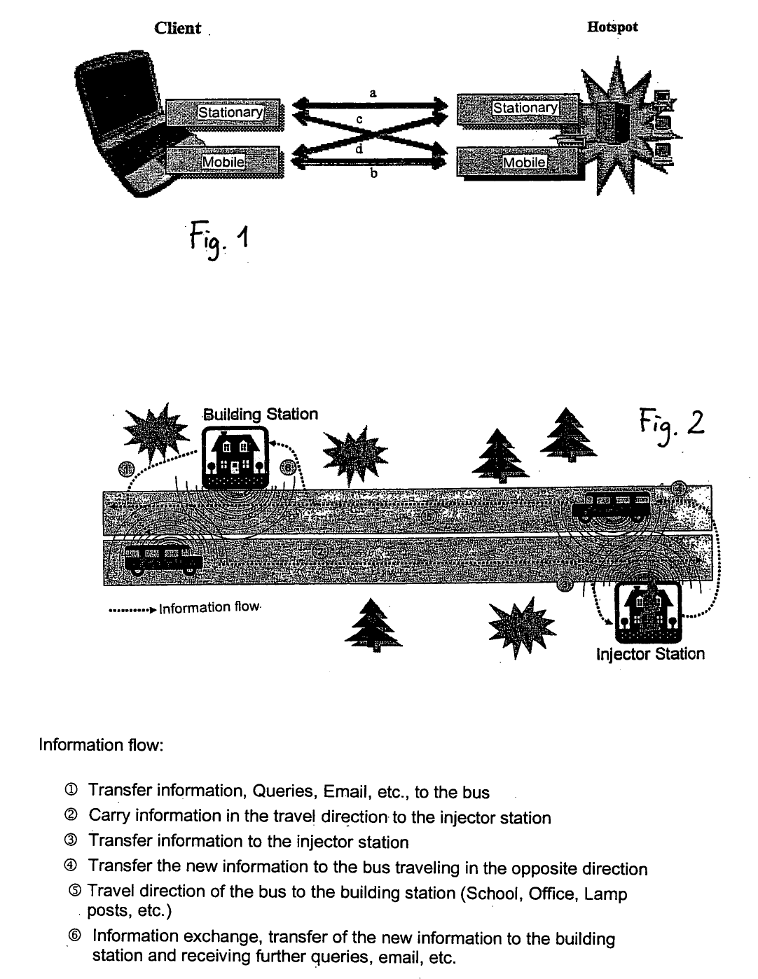

The described systems themselves do not yet include a definition relating to the movement of the client or other participating components. If mobility is included in the functionality as a new property, then the categories depicted in FIG. 1 are obtained. While hotspots and clients are stationary in category a), as may be the case, for example, with networked workstations that do not use wired connections, the categories b) and c) are mainly encountered in ad-hoc networks. The invention described below extends the potential use of mobile clients in stationary hotspots (depicted in FIG. 1 as point d). Many public hotspots and the clients used in these hotspots belong to this category; however, the mobility of the clients is severely limited in conventional systems, because the conventional systems support only low speeds.

Roaming Methods:

The employed roaming methods are an important aspect of these systems. Several roaming methods are known, in particular MobileIP. It is also known to assign IP addresses to computers via DHCP. It is also known that client systems can be authenticated via RADIUS and that the communication between wireless client systems and the access point can take place via IEEE 802.1X. An existing routing protocol known in the art ensures that a packet finds its way between access point and transfer point.

It was until now necessary to install a special program code on the client system (MobileIP client) to enable roaming in the computer network with current technology. This program code is not available or desirable for all client systems, so that MobileIP is not generally applicable to all client systems.

It is also known that a number of technologies, for example IEEE 802.11(a, b, g), IEEE 802.16a, WLL (Wireless Local Loop), or Bluetooth can be used to provide wireless data communication with stationary clients. Additional solutions exist for data communication with mobile clients. The best-known technologies are GSM (Global System for Mobile Communications) and based thereon, GPRS (General Packet Radio Service), or UMTS (Universal Mobile Telecommunication). Also known are technologies for wirelessly connecting rail vehicles to a computer network. For example, the Company “21Net” offers a system which uses a satellite downlink for transmission to the vehicle and a conventional mobile telephone connection (GSM) for the return path. It is also known that roaming is seamless when transitioning from one wireless cell to the next wireless cell, i.e., the existing data or voice connections are maintained during the transition. It is also known that access to the Internet is obtained via so-called Internet Service Providers (ISPs).

Disadvantageously, the existing systems are limited to stationary clients and/or to clients that move at low speed. The transmission bandwidth is also quite small.

It is therefore an object of the invention to provide a system and a method for roaming in access regions of the data and/or communication networks for use with a client moving at a high speed, as well as a corresponding computer program and a corresponding computer-readable storage medium, which obviates the before-mentioned disadvantages and provides, in particular, a simple and cost-effective solution for access to Internet services when traveling on high-speed routes.

This object is solved by the invention by the features recited in claims 1, 12, 19, and 21. Advantageous embodiments of the invention are recited in the dependent claims.

In the system according to the invention for roaming in access regions of data and/or communication networks for use with a client moving at a high speed, there is provided that access points (AP) are arranged along the travel route of the client for providing wireless access to data and/or communication networks, for example the Internet, wherein at least one AP is directly connected with the data and/or communication network by a communication link, and wherein APs without a direct connection to the data and/or communication network are connected by communication links to the APs that have a direct connection to the data and/or communication network.

According to an advantageous embodiment of the system of the invention, the travel route of the client can be covered in its entirety by the illumination areas of the APs (continuous architecture). Alternatively, the travel route of the client can be covered partially by the illumination areas of the APs (semi-continuous architecture). In this case, continuous communication is maintained by mimicking to the stations the existence of the connection, when a client leaves an AP or hotspot area. The connection is re-established when the client enters the next hotspot, and data are exchanged.

Moreover, APs without a direct connection to the data and/or communication network can advantageously have a wireless communication link to at least one of the neighboring APs. In particular, the complexity of the equipment is reduced if only one wireless connection is set up to a neighboring access point.

A solution of the method of the invention for roaming in access regions of data and/or communication networks for use with clients moving at a high speed, wherein the data and/or communication network includes access points (AP) for wireless access of data processing devices and/or communication terminals (clients) as well as a computer system for automatically routing the data within the data and/or communication network, provides that the computer system transmits information about clients to those APs that are located in the travel direction of the client(s).

Advantageously, in a preferred embodiment of the method of the invention, no additional roaming software needs to be installed on the client, because when the client switches from the area of one access point to the area of another access point (roaming), the network-internal computer system for automatic routing of the data assigns an identification to the client, for example an IP address.

A corresponding system for roaming in data and/or communication networks, wherein the data and/or communication network includes access points (AP) for wireless access of data processing devices and/or communication terminals (clients), as well as a computer system for automatically routing the data within the data and/or communication network, as well as a computer system for automatic routing of the data within the data and/or communication network, is characterized in that the network-internal computer system for automatically transmitting of the data is configured so that the network-internal computer system for automatically transmitting the data assigns to the client an identification, for example an IP address, when the client transitions from the area of one access point to the area of another access point (roaming).

According to an advantageous embodiment of the system of the invention, the Internet is used as data and/or communication network. More particularly, the system of the invention can be advantageously employed if the data and/or communication network includes an autonomous, self-administered network, for example a Local Area Network (LAN). It is hereby advantageous, if the autonomous self-administered network includes one or more transition points to another data and/or communication network, for example the Internet.

According to an advantageous embodiment of the method of the invention, when the client enters an area of an access point, in particular during roaming, the client is logged on at this access point. In a particular embodiment, with each log-on, the client is authenticated and/or the client is assigned a transition point to the Internet. This enhances the security of the communication and also aids in correctly routing the data.

According to another advantageous embodiment of the system of the invention for roaming, at least one module of the network-internal computer system for automatically routing the data is installed on a central server, and at least one module of the network-internal computer system for automatically routing the data is installed on at least a portion of the access points, wherein
the module(s) installed on the central server is/are configured so as to be able to authenticate and administer the client's identification, and
the module(s) installed on the APs is/are configured so as to be able to perform the association of the transition points.

Accordingly, a central site exists that administers the IP addresses and the transition point for each client system.

According to a particular embodiment of the roaming method of the invention, it is provided that, when a client enters the area of an access point,
the client is authenticated at the central server,
an identification, for example an IP address, is transmitted to the access point by the central server,
transition points to other networks are determined by the access point,
the identification and a transition point is assigned to the client by the access point, and
the transition point assigned to the client routes of the data identified by the client's identification to the access point.

Advantageously, connections existing on the client remain in existence during roaming. It is also advantageous if the client is always assigned the same identification during roaming. In another advantageous embodiment, load balancing can be performed through suitable selection of the transition points.

According to another preferred embodiment of the system of the invention, the system is configured so that the wireless communication is implemented by a method using Orthogonal Frequency Division Multiplexing (OFDM).

According to another advantageous embodiment of the system of the invention, the system is configured so that one of the IEEE 802.11 technologies, for example the IEEE 802.11a, the IEEE 802.11b, or the IEEE 802.11g technology (hereinafter abbreviated as IEEE 802.11a/b/g), is used as technology for wireless transmission of the data. In an alternative embodiment, one of the IEEE 802.16 technologies, for example the IEEE 802.16a, the IEEE 802.16d, or the IEEE 802.16e technology (hereinafter abbreviated as IEEE 802.16a/d/e), is used as technology for wireless transmission of the data. This has the significant advantage that only relatively few access points are required for the servicing a route, because the illumination area is larger in comparison to the IEEE 802.11a/b/g technology. Moreover, a greater communication bandwidth is available.

Advantageously, a one-to-many point communication system can be used, because several clients can then communicate simultaneously with a transmission station.

According to another advantageous embodiment of the system of the invention, the access points are connected to the Internet wireless and/or wired. It is also advantageous if the access points are networked with each other either wireless or wired, or both, and if at least several of the access points have a connection to the Internet. Advantageously, the wireless connections are implemented as a line-of-sight wireless link, whereas the wired connections are implemented using copper and/or glass fiber cable. The system of the invention can advantageously be expanded to provide additional satellite uplinks and/or downlinks as data transmission links.

According to a particular advantage of the invention, the method and/or system of the invention are configured, so that the IEEE 802.16a/d/e technology can be used for moving clients. More particularly, the IEEE 802.16a/d/e technology can then be used for clients that move at high speed; for example, by setting up corresponding transmitter/receiver towers along the routes, for example along roads, rail lines or waterways. Advantageously, this technology requires a significantly smaller number of access points compared to conventional solutions, thus significantly reducing the expenses for material and the costs.

According to another advantageous embodiment of the system of the invention, the system is configured so as to be usable for Voice-over-IP (VoIP).

A computer program according to the invention enables a computer, after the computer program is loaded into the memory of the computer, to execute a method for roaming in access regions of data and/or communication networks for use with a client moving at a high speed, wherein the data and/or communication network includes access points (AP) for wireless access of data processing devices and/or communication terminals (clients) as well as a computer system for automatically routing the data within the data and/or communication network, and the method includes the following step:
transmitting information about the clients to those APs that are located in the travel direction of the client(s).

Advantageously, the computer program may include several modules, with at least a first module installed on a central server, and at least one corresponding second module installed on the APs.

For example, these computer programs can be provided for downloading in a data or communication network (either with or without a fee, or freely accessible or protected by a password). The computer programs provided in this way can be used by a method, wherein a computer program according to one of the claims 17 or 18 is downloaded from an electronic data network, for example from the Internet, to a data processing device connected to the data network.

For particular applications, a computer-readable storage medium can advantageously be employed, on which a program is stored that enables a computer, after the program is loaded into the memory of the computer, to execute a method for roaming in access regions of data and/or communication networks for use with a client moving at a high speed, wherein the data and/or communication network includes access points (AP) for wireless access of data processing devices and/or communication terminals (clients) as well as a computer system for automatically routing the data within the data and/or communication network, and the method includes the following step:
transmitting information about the clients to the APs that are located in the travel direction of the client(s).

The roaming method and system according to the invention therefore offers the following advantages. The client system has access to a local, autonomous, self-administered network, and has access to the Internet via the local network, regardless of the access point at which the client system is logged on to the network. The client system can move freely within the network, without interruption of existing connections (seamless roaming).

No additional software, such as MobileIP, needs to be installed on the client system. The only prerequisite for mobile operation is that the client system supports the Internet protocol. Load balancing is possible by using several transition points to the Internet that already exist in the local network. The achieved redundancy increases bandwidth, stability and security of the communication in the local network.

Advantageously, the roaming method and system according to the invention can be used for wireless communication of mobile clients with a data and/or communication network. This significantly reduces the number of access points required for the communication compared to conventional solutions, in that access points for wireless communication between the clients and the data and/or communication network are provided along the routes used by the mobile clients, for example along freeways, rail lines or waterways.

Embodiment of the present invention will be described hereinafter with reference to the appended drawings.

It is shown in:

FIG. 1: a schematic diagram of hotspots with reference to speed;

FIG. 2: an ad-hoc network with buses;

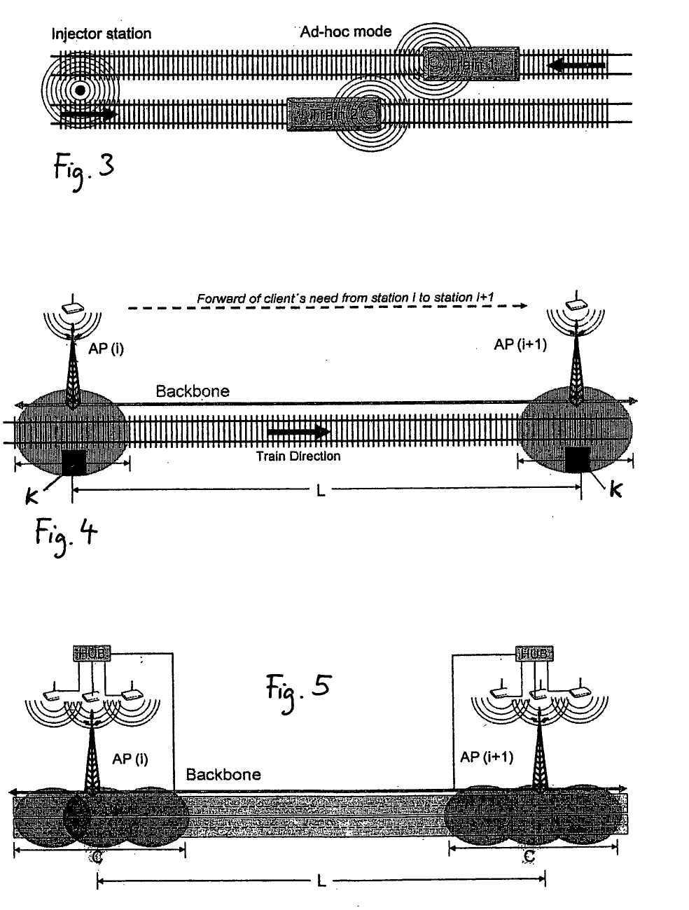

FIG. 3: an ad-hoc network with trains;

FIG. 4: a semi-continuous architecture with discrete injector stations, with a rail line as an example;

FIG. 5: several stations operating in parallel and employing load-balancing methods;

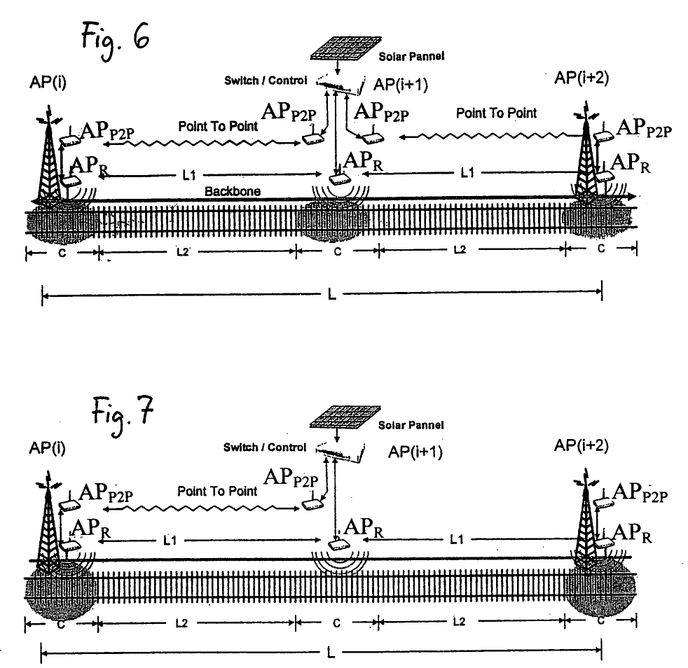

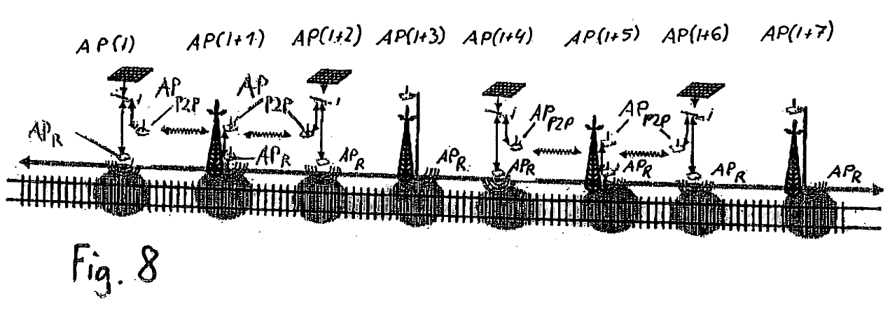

FIG. 6: a semi-continuous architecture with discrete injector stations and a bilateral wireless backbone (Example 1);

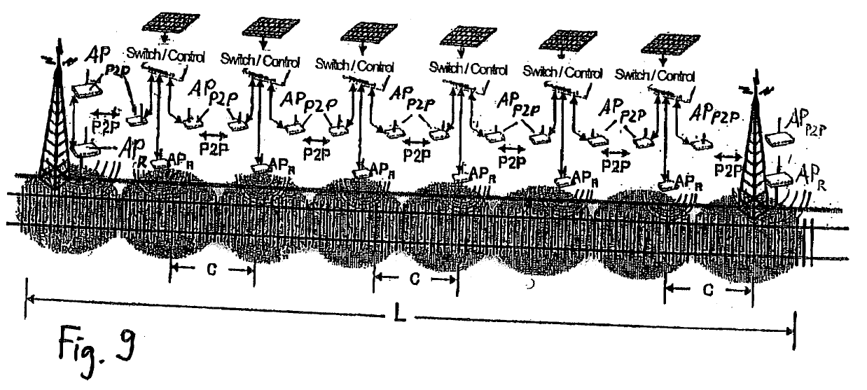

FIG. 7: a semi-continuous architecture with discrete injector stations and a unilateral wireless backbone (Example 2);

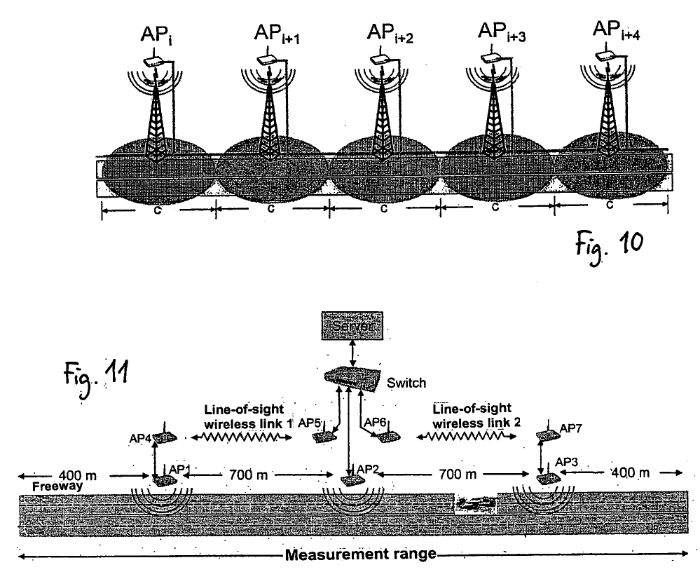

FIG. 8: a medium density ad-hoc network with several stations;

FIG. 9: a high density ad-hoc network with discrete injector stations and wireless backbone;

FIG. 10: a high density ad-hoc network along a freeway;

FIG. 11: a test configuration arranged along the freeway;

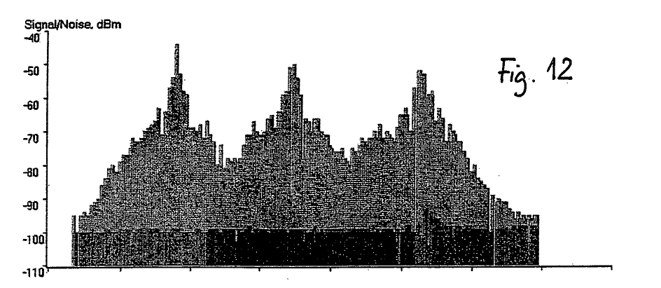

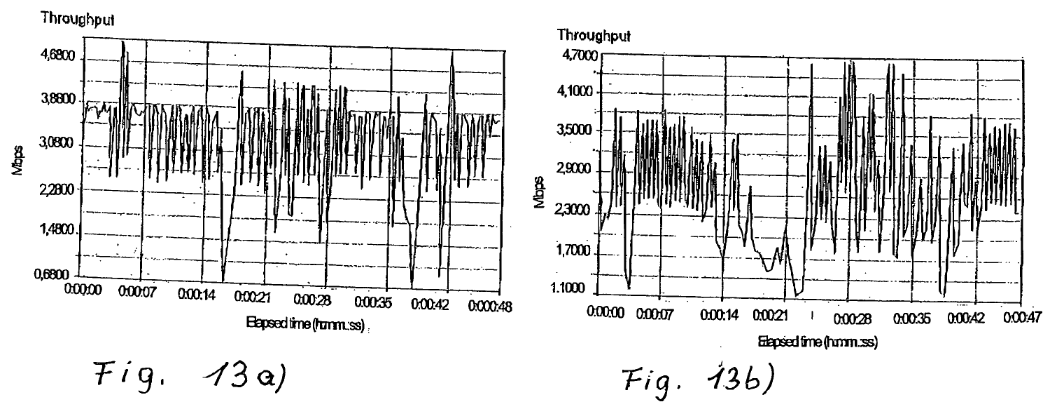

FIG. 12: an illustration of the connection quality at 100 km/h, Network Stumbler;

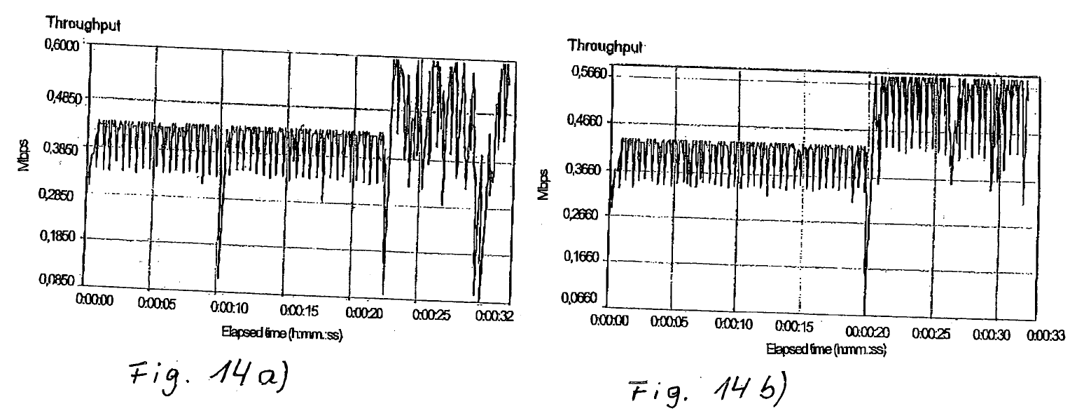

FIG. 13: an illustration of the data transfer rate at 130 km/h for TCP (13a) and UDP (13b);

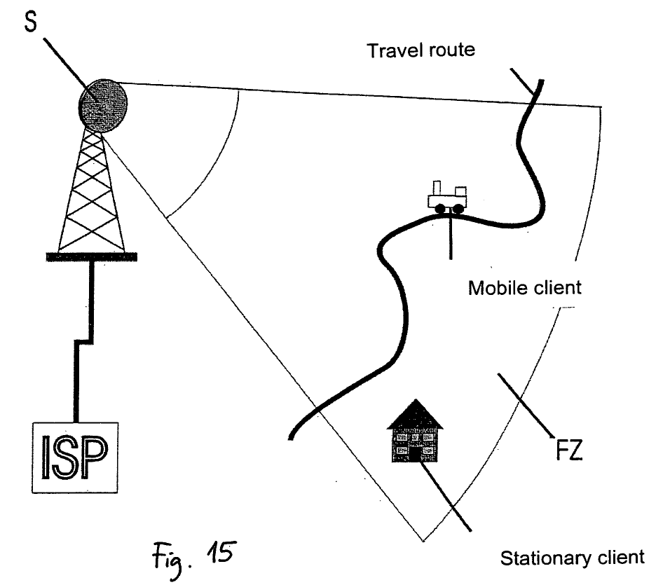

FIG. 14: roaming at 170 km/h for TCP (14a) and UDP (14b);

FIG. 15: a diagram of the basic design of a system according to the invention for use with clients that move at high speed;

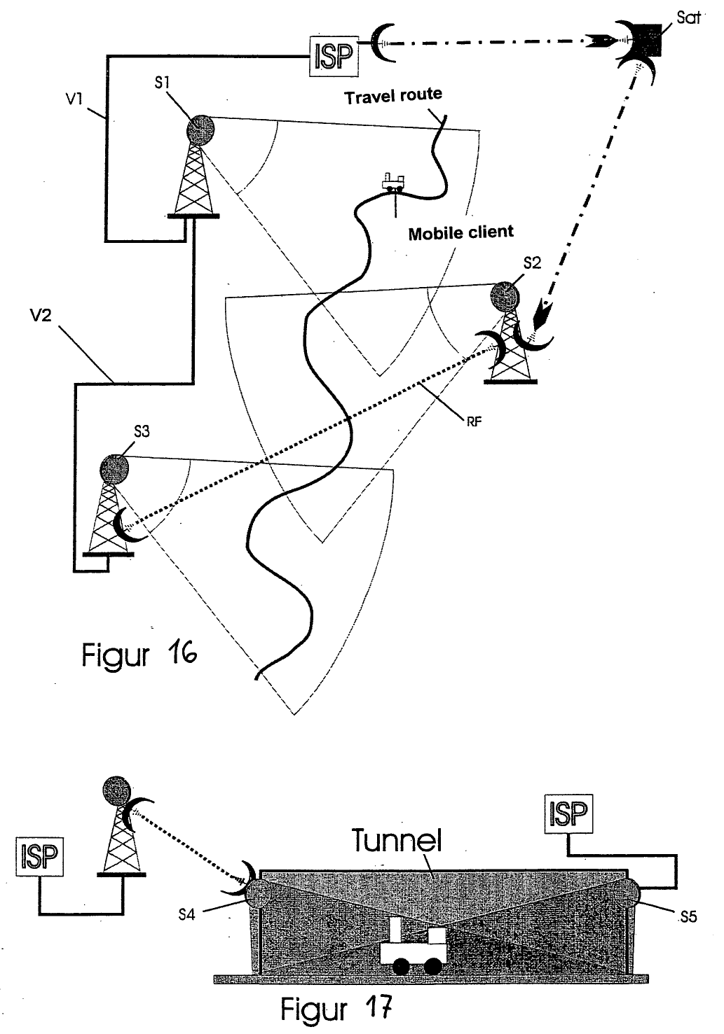

FIG. 16: a diagram of the operation of a system according to the invention for use with clients moving at high speed, with reference to an embodiment having greater complexity;

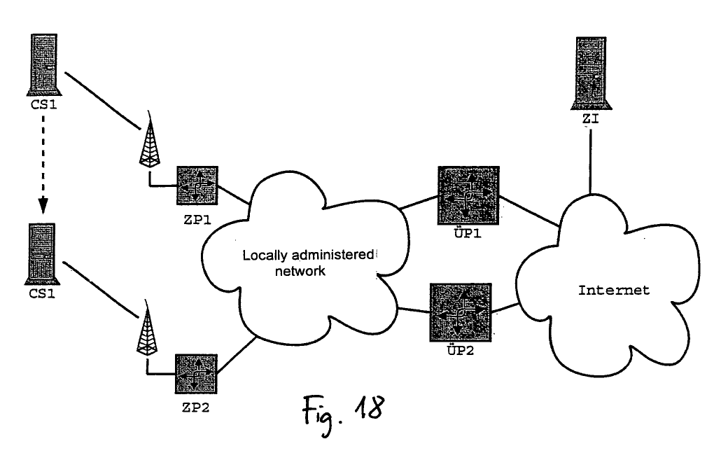

FIG. 17: an illustration of the use of the system according to the invention for enabling mobile clients to communicate in tunnels; and

FIG. 18: a basic structure of the computer network for roaming of mobile client systems.

The basic characteristic of today's wireless networks according to the IEEE 802.11a/b/g standard is their stationery use in so-called single domain hotspots, as implemented, for example, at train stations, airports or universities.

The wireless communication on the basis of these WLAN systems, however, has a significantly greater potential, especially in the field of mobile communication. With the invention, Wireless LAN according to IEEE 802.11a/b/g in the 2.4 GHz band does not suffer from a decrease in the signal quality and bandwidth even at speeds of 200 km/h. Accordingly, different scenarios can be developed for mobile clients, which will be described hereinafter in more detail.

Wireless communication is conventionally set up by providing so-called hotspots which allow clients access to networks. The scenario presented here employs another approach, which enhances the ability of clients to directly communicate with other clients. In principle, WLAN operating in Ad-hoc Mode supports such approaches. In Ad-hoc Mode, at least two computers form an independent peer-to-peer (P2P) communication network. These networks do not require a stationery infrastructure with access points (AP), so that they can be established at a location by at least two WLAN-enabled devices.

However, the configuration and resource distribution of such networks is not flexible enough for day-to-day use, although they can have advantages in particular scenarios. Exemplary scenarios can include clients moving at high speed, which can form, during their travel, mutual ad-hoc networks, exchange information, and carry information to other locations.

Possible applications are, for example, regional commuter traffic using buses and streetcars. When the buses meet, they exchange the most up-to-date information. The buses continue on their route and meet other buses and again exchange information, so that the information is available in all buses after a certain (latency) time. To feed the information into the network, a few “injector stations” are installed at important nodes. Accordingly, each bus has the newest information after a certain time, referred to as update time. A classic network is therefore unnecessary.

Such scenario can also be employed in trains. Because travelers tend to remain in the train for a longer time, the system can be provided to these users or clients on the train.

A system of this type, for example a system using buses (see FIG. 2), can also be used for transporting information. For example, areas may exist in a city which lack Internet access, for example schools, due to the lack of financial resources, or areas that control or switch certain processes on and off, etc. A WLAN ad-hoc unit with corresponding computer systems and Internet tools can be installed in these areas. When the buses travel past these areas, e-mail, Web queries, reactions to control tasks and the like, are transmitted to the bus, where they are stored. The bus then carries the information to the injector station and deposits the information at the injector station. The next bus traveling in the opposite direction receives the e-mailed replies, received e-mails, the Web queries and new control tasks and in turn delivers these to the school, control stations and the like, when the bus arrives at these locations.

An architecture of this type can be used, for example, for supplying an information system within a vehicle. Advertising, travel information, news, videos, etc., can be continuously and frequently updated by the injector station on a display and displayed in the vehicle.

Other scenarios can also be used for those areas that lack network access to the Internet (e.g., remote villages, remote construction sites, etc.). In this way, the transport units become carriers of information, thus resembling in a classical sense an electronic mail man. FIG. 2 shows the basic structure of the scenario with the corresponding components.

Another exemplary scenario is an arrangement for trains in a rail network (FIG. 3)

In this arrangement, two passing trains form an ad-hoc network for exchanging information. The injector station provides the trains with the newest information. In this way, information can be handed over from one train to another, so that after a certain latency time all trains have the same information available.

If several trains reach the injector station simultaneously, then they are also supplied simultaneously. For example, a broadcast communication may be established. This scenario can also be used for stations that receive information from the trains, for example for controlling devices located along the track.

The latency time for spreading the news depends essentially on the number of the trains and the frequency with which they meet. The timeliness of the information depends on the frequency with which the information is injected into the system.

These scenarios can essentially include three different types of stations:
Injector Stations (also referred to as Base Stations), which, on one hand, can provide wireless communication with the buses and, on the other hand, can set up a connection to the Internet through an Internet provider. The injector station therefore represents a WLAN hotspot for setting up a wireless connection between a vehicle (bus, train, ship, etc.) and a wired backbone network, such as the Internet. The only prerequisite is compatibility with the employed WLAN standard. Consequently, such stations must be installed, if possible, at locations with access to the backbone, for example at rest stops, train stations and the like. When a vehicle arrives, an ad-hoc network is set up between the vehicle and the injector station. Both stations can exchange data during this time. The injector station updates information in the vehicle. When the vehicle travels onward and meets another, second vehicle, the information is transmitted to the second vehicle, if the first vehicle had previously received the information from another, third vehicle or from an injector station.
Mobile Stations (also referred to as Bridge Stations), are vehicles which act as information carriers and can transport the information within their traveled area. These mobile stations can, on one hand, set up ad-hoc networks among themselves and exchange information. Each vehicle then provides the newest available information to the other vehicles. This produces a mutual update of stored data. Thereafter, all vehicles have the same information. However, the vehicles can also exchange information with the injector stations and receiver stations. The vehicles provide their information to the injector station for transmission to the Internet and receive the newest data from the station. The vehicles transport the information to the receiver stations.
If two vehicles meet in the aforedescribed manner, then an ad-hoc network is established between them, resembling a bridge function. This type of stations has hybrid properties due to their position in the network. However, the basic idea lies in their mobility, i.e., bridge stations move along predetermined routes, and are installed, for example, in vehicles, trains or commuter rail cars. They represent, on one hand, a client for contacting other injector or mobile stations, and, on the other hand, a base station for communication with receiver stations, thus enabling bidirectional communication.
Receiver Stations are stations without Internet connection, which establish Internet access through the vehicles. The data destined for the Internet are thereby transmitted to vehicles passing nearby, which vehicles then transport the data to the injector station, receive the replies, and transmit these to the receiver stations.
The receiver stations behave like a client and represent a type of consumer or user in the system. They either use an injector station directly, or use the information service of a mobile station. Because the mobile stations have only temporarily access to each other or to the injector stations, information is updated to the backbone network with a delay. This must be taken into consideration when selecting the services, for example instant messaging, billings in trains, buses, etc.
End-User (Client) use available services (e-mail, Web, etc.) at the mobile stations or in vehicles (trains, buses, etc.), but also at the receiver stations for intranet or Internet access to available services. For example, a logged-on and authorized end-user in the vehicle sends an e-mail, which is received by the mobile station and delivered to the next injector station. The reply is obtained at the next injector station and transmitted to the end user.
If a message cannot be delivered, because the user has logged off or left the vehicle, then the message is stored at a central location where the user is registered and known. If the user logs on again, then the message will again be available to him.

As already mentioned, information exchange between mobile and injector stations is frequently possible only for short periods of time. These times depend on the speed of the vehicle, but can be significantly increased by employing suitable directional antennas, for example in high-speed trains.

The volume of the transmitted information relating to the speed of a vehicle can be computed as follows:

First, the combination of a mobile station and a stationary station (receiver or injector station) will be described.

Residence Time at a Hotspot:

The speed of a vehicle is assumed to be g [km/h]. The illumination area of an access point (AP) at a receiver or injector station is assumed to be a [m]. Therefrom, the residence time t_{Ad-hoc} at the hotspot in ad-hoc mode, i.e., the time during which the vehicle is located within an ad-hoc network, can be computed as:
t_{Ad-hoc}=a/g.
Numerical example: a=1500 m, g=60 km/h,
t_{Ad-hoc}=1500 m*60 min /60*1000 m=1.5 min=90 s.
   Transmission Rate:

These times form the basis for computing the achievable bandwidths. The transmission rate u [Mbps] or u/8 [MBps] is computed as follows:
d_{Ad-hoc}=t_{Ad-hoc}*(u/8) MBps.

Numerical example: For an assumed low net transmission rate of approximately 4 Mbps or 0.5 MBps according to the IEEE 802.11b standard, about
d_{Ad-hoc}=90 s*0.5 Mbps=45 MB
could be transmitted within the ad-hoc network. Four to five times this volume, i.e. a data volume of approximately 20 MB, could be transmitted during the same time by using 802.11a and 802.11g.
Wireless Bridged Network:

The systems described below are based on the concept of providing a semi-continuous or continuous network connection for mobile stations along a route. Cost-effective communication networks along a traffic route, for example a rail link or a freeway, can be implemented based on the WLAN technology according to IEEE 802.11a/big by employing the different types of architectures.

The semi-continuous or continuous network connections result in different types of communication architectures for vehicles traveling along a road or rail link. Several exemplary architectures will be described below:

Semi-Continuous Architecture

In such architecture (FIG. 4), APs which are spaced apart by discrete distances L and have their own hotspot are employed along the route. Each hotspot represents an illumination area with a radius k. The mobile station travels along the route and changes from one hotspot AP (i) to another hotspot AP (i+1), each of which assumes the function of an injector station. A semi-continuous connection with a low density characteristic (partially connected architecture with low density characteristic) exists, if the hotspots have a separation of L>>k, i.e., their spacing is such that the mobile station, after leaving a hotspot, is not connected to the two adjacent injector stations AP(i) and AP(i+1) for an extended period of time. Such scenarios could exist, for example, at:
filling stations along a freeway,
along a freeway with, for example, discretely spaced emergency call boxes,
along a rail line on the masts for the GSM-R stations,
at the train stations along a rail line.

Consequently, the mobile stations (vehicles) experience “online” and “silent” times which, however, should not be viewed as off-line times (see below).

Communication with an injector station is possible during the online time, but not during the silent time. The distance equivalent to the silent time, during which communication cannot take place, is L-k.

To maintain continuous communication, a single IP address is used along the entire route. Because the stations are connected via the backbone, the entire system represents a stand-alone network, so that this address for the vehicle can be assumed to be valid during the entire time. To enable this approach, mechanisms are required that prevent network interruptions. In this case, the existence of a connection is mimicked to the stations when the vehicle leaves the AP or hotspot area. The connection is re-established when the vehicle enters the next hotspot, and data are exchanged.

Forwarding:

The situation can be improved by providing the next station (AP) with advance information about the arrival of the vehicle. This process is referred to as “Forwarding.” A station AP(i) provides the corresponding information to station AP(i+1) for all vehicles traveling in the direction of station AP(i+1). The station AP(i+1) can hence be informed about the actual situation and can make appropriate arrangements. This process resembles a look-ahead process and is used to optimize communication in the entire system.

Look-Ahead Method

The look-ahead method and forwarding of status information makes it possible to structure the architecture so as to improve communication. The current activities of a client c traveling from a hotspot AP(i) to the hotspot AP(i+1) are thereby already announced to the hotspot AP(i+1) at hotspot AP(i). The hotspot AP(i+1) is then informed about the actions of client c and is able to prepare for these activities. For example, queries or e-mails are available to the client c as soon as he arrives at the hotspot AP(i+1).

Services

Due to the temporary nature of the connection, the selection of services depends on the respective operational area. For example, vehicles within the hotspot area, for example trains in a train station, can update their video and audio programs, because sufficient time is available in this situation. During the trip, possibilities exist for instant messaging or, as an interesting alternative, to pay for the trip via the system. Surfing the WWW can also be supported, because the stations temporarily store requested Web pages and update the Web pages upon contact with the next station.

Forwarding

The status information to be forwarded includes essentially
which vehicle (client) will arrive shortly at the location (address, category, state, etc.),
which information is currently requested by the vehicle (e-mails, Web queries, data transmission, etc.),
which data are to be transmitted (e-mails, Web queries, data transmission, etc.),
the speed of the vehicle (client),
. . .

In this way, the next station can make the necessary preparations to initiate transmission of the data when the vehicle arrives and can also inform the station thereafter about the actual state.

Bandwidths

The separation and the resulting bandwidths in connection with the speed of a vehicle can be computed as follows.

Hotspot Residence Time

The hotspots are assumed to have a spacing L. The speed of the vehicle (train) is assumed to be g [km/h]. The length of the illumination area of a hotspot AP is assumed to be C [m]. The hotspot residence time tₕₒₜₛₚₒₜ of the vehicle, i.e., the time during which a vehicle remains within a-hotspot, can be computed as:
tₕₒₜₛₚₒₜ=C/g [S].

The time required for a client to travel from one hotspot AP(i) to the next hotspot AP(i+1) then becomes
tₛₑₚₐᵣₐₜᵢₒₙ=L/g [s].
Silent Time

The silent time is obtained from the difference between the two equations:
tₛᵢₗₑₙₜ=tₛₑₚₐᵣₐₜᵢₒₙ−tₕₒₜₛₚₒₜ=(L−C)/g [s].
Numerical Example:
C=1400 m, g=120 km/h, L=10 km
tₕₒₜₛₚₒₜ=(1400 m*60 min)/(120*1000 m)=0.7 min=42 s
tₛₑₚₐᵣₐₜᵢₒₙ=(10−1.4)*1000 m*60 min/(120*1000)=4.3 min=258 s.
Achievable Bandwidths

These times form the basis for computing the achievable bandwidth: the average transmission rate in the hotspot is assumed to be U MBps. In a first approximation, the total data volume D that can be transmitted in a hotspot, can be computed as follows:
Dₕₒₜₛₚₒₜ=U*tₕₒₜₛₚₒₜ=U*C/g [MB].

An exact calculation is obtained by taking into consideration the actual transmission rates along partial routes (for example, stepped areas in a WLAN).

Numerical example: For an assumed low net transmission rate of approximately 4 Mbps or 0.5 MBps according to the IEEE 802.11b standard, a total of approximately 21 MB can be transmitted within the hotspot. Four to five times this volume, i.e. a data volume of approximately 100 MB, could be transmitted during the same time when using 802.11a and 802.11g.

Conversely, if GSM were used, a continuous communication would be available during the entire travel of a vehicle of 5 min=300 seconds from a hotspot AP(i) to hotspot AP(i+1); however, only a total data volume of 4.32 Mb (14.4 kb*300 s) or 0.54 MB could be transmitted.

System Enhancement

The equations listed above form the basis for dimensioning a route. The number of the simultaneously existing mobile stations or the simultaneously operating clients (in particular along freeways) must be considered in addition. Many vehicles can be present in a hotspot, depending on the illumination area of a hotspot. This situation can occur if, for example along a freeway, several vehicles wish to communicate simultaneously with an injector station. Because the WLAN shared medium concept provides the available bandwidth to all WLAN subscribers, each client has on the average available only a portion of this time. A first coarse approximation for the available bandwidth during a simultaneous communication of all subscribers with the hotspot can be determined by linearly partitioning the time tₕₒₜₛₚₒₜ, which results in identical portions for each of the subscribers. This situation is best applied to a rail line, because only a limited number of trains are present along a particular line.

An improvement is obtained by employing additional stations operating in parallel. In each WLAN hotspot, an AP group can provide up to three parallel frequency bands. The three APs are connected via a hub with the high-speed backbone. In this way, the vehicles to be supplied can be subdivided into three groups. A load-balancing method is used to subdivide the groups. The potential clients in three groups can each communicate with one AP (see FIG. 5).

Partially-Connected Architecture with Medium-Density Characteristic

The silent times can be shortened by providing additional intermediate stations, e.g., another station between the already existing stations. This cuts the silent distance in more than half, because the new station supplies a portion of the route with an additional online area (see FIG. 6). The silent time can be calculated for a vehicle traveling at a speed g as follows:
tₛᵢₗₑₙₜ=L2/g=(L1−C)/g=((L2)−C)/g=((tₛₑₚₐᵣₐₜᵢₒₙ−2 tₕₒₜₛₚₒₜ)/2)−C/g [s].

Two examples with different architectures can be identified with this category:

### EXAMPLE 1

### Two-Sided Wireless Backbone

Assume that the APs can be connected to the backbone, coupled to the network, and supplied with power only at the masts, with a spacing of, for example, every L km. In this case, the station AP(i+1) in the center (see FIG. 6) is connected to the wired backbone to the adjacent stations AP(i) and AP(i+2) by a corresponding wireless link. For all vehicles traveling from left to right, the left station AP(i) forwards the status information over the left wireless transmission link to the center station AP(i+1). When the vehicle leaves the center station AP(i+1) and continues on its way, the information is transmitted over the right wireless transmission link to the right station AP(i+2). The same applies in the opposite direction, when a vehicle traveled from right to left, whereby the forwarding status information is transmitted from the right station AP(i+2) to the center station AP(i+1), and from the center station AP(i+1) to the left station AP(i). The data are transmitted over the wireless backbone connections between the hotspots AP(i) and AP(i+1), and between AP(i+2) and AP(i+1), as illustrated in FIG. 6. Each partial route then has its own wireless connection. This generates a pipeline for information transmission.

### EXAMPLE 2

### One-Sided Wireless Backbone

The complexity can be reduced by employing only one wireless link on one side (see FIG. 7). In this case, forwarding and transmission of status information from the station AP(i+2), which then has no wireless connection to the station AP(i+1), is transmitted via the wired network to AP(i) and forwarded by this station to the hotspot AP(i+1).

In this architecture, the two types of stations alternate:
Stations that do not enable connection of wireless backbones to respective adjacent stations, and
Stations that are connected to the system via a wireless backbone link.

Another variant of the architecture is obtained by connecting every second station that is connected to the wired backbone with the adjacent stations by a wireless link (see FIG. 8). This also reduces the cost for implementation, because the cost for coupling the wireless stations (server installation, component installation, etc.) can be optimized.

In this case, the architectures can produce approximately the same results as in Example 1, as long as the backbone networks provide sufficient capacity, which should not present a technical problem. The bottleneck through the station AP(i) can be compensated by increasing the computing power to speed up data transmission.

Solar Cells

Because the center AP was assumed to lack a dedicated power supply, power can be supplied through alternative energy sources, such as solar cells or wind power, to reduce costs. For example, a solar cell area of approximately 1 m² is sufficient to supply the AP with power.

Architecture for Continuous Network Connection

Always-Connected Architecture

Uninterrupted access can be achieved by increasing the number of hotspots (APs) along the route. The hotspots are arranged so as to completely illuminate an area. Roaming between the stations enables a seamless transition between adjacent hotspots AP(i) and AP(i+1). This architecture also entirely eliminates the silent times, hence providing a continuous connection to the global network.

The architecture can be used all types of vehicles, e.g., in trains (see FIG. 9) and along freeways (see FIG. 10). The scenario for trains represents an extension of the aforedescribed architectures, which allow coupling to the wired backbone network only at certain points.

In this case, the entire route is covered by a network of sequentially arranged wireless WLAN hotspots. This architecture represents an extension of the earlier examples. The backbone network can consist of a mix of wireless and wired (see FIG. 9) backbones, or of only a wired backbone (see FIG. 10). If a wired backbone is not available, then a backbone using exclusively wireless stations is also feasible.

Exemplary embodiments of the first two cases will be described in more detail below. The third case can be viewed as a special form of the first case.

In the first case, information between intermediate stations is transmitted from one station to the next via the wireless backbone. The two stations, which are arranged in the vicinity of the wired hotspots, are integrated in a similar manner (see FIG. 6), and in turn supply the wireless stations in their vicinity. These stations and the other wirelessly connected stations perform in addition the function of a relay station or bridge station and transmit information to adjacent stations.

The second case assumes a scenario on a freeway, whereby coupling to the wired backbone is available at each location (FIG. 10), so that wireless coupling of the intermediate stations is not required. This enhances performance during data transmission.

Architectures with continuous network access enable consistent and seamless transmission of information (without silent times), for example for voice and movie services, for making telephone calls via the WLAN network, and the like.

It the following, a special configuration for implementing the invention will be described in detail. The advantages of the invention are exemplified through comparison with other wireless communication technologies, such as GSM, DECT, or HiperLAN. Table 1 shows an overview of the systems together with the WLAN according to IEEE 802.11b, which is preferred according to the invention. In particular, the indicated maximum speed of the user is of interest, which is relatively high with 250 km/h for GSM, but is relatively low at less than 10 m/s for HiperLAN.

TABLE 1
Comparison between wireless communication technologies [5] [6]

| Standard | GSM | DECT | WLAN 802.11b,g | HiperLAN |
|---|---|---|---|---|
| Band | 900/1800/1900 MHz | 1900 MHz | 2.4 GHz (DSSS) | 5.15-5.25 GHz |
| Bit rate | 270.8 Kbps | 1,152 Kbps | 1-54 Mbps | >20 Mbps |
| Number of carriers | 125 | 10 | 14 max. (regional | |
| | | | differences) | |
| Channels per | 8 | 24 (12 duplex) | variable | |
| carrier | | | | |
| Cell size | <35 km | <50 km | Indoor <50 m | Indoor <50 m |
| | | | Outdoor <500 m | Outdoor <500 m |
| Speed of user | <250 km/h | <50 km/h | Evaluated herein up | <10 m/s |
| | | | to 90 km/h | <36 km/h |

The implementation described below is an extension of projects and measurements performed at speeds reaching 90 km/h (see [7]). The investigations in the context of this particular implementation produced an important result, namely that the invention can be used in practice at high speeds.

A Particular Implementation of the Invention and Evaluation Scenarios Configuration of the Communication Network

Since it was necessary to achieve high speeds, a route was a selected along a section of a public freeway. FIG. 11 shows schematically the configuration of the 2.2 km long route. For performing the measurements at high speed, a route along the highway with a total of seven access points (AP) and a switch and a stationary server for networking the APs with each other were set up. The APs 1 to 3 are used for communication with mobile clients along the freeway. The APs 4 and 5, and 6 and 7, each form a line-of-sight wireless link to integrate the two APs in the communication network. The AP 2 is coupled to the network by a cable, for example a 100 m long Ethernet cable. The stationary server was also coupled to the network via an Ethernet cable and assumed all organizational tasks and attended to the mobile clients. This arrangement topologically defines a stationary hotspot with three WLAN cells, having an internal separation of 700 meters.

Technical Data

The measurements were performed using components from the company Enterasys. An R2 access point with two WLAN cards was used for each of the outer access points AP1 and AP2, and AP6 and AP7. The first card (AP1) was amplified by a 7 dB omnidirectional antenna and established the infrastructure cell of the hotspot, while a wireless link to the central station was a set up via the second card (AP2) by using a 14 dB Yagi antenna. The high antenna gain and the resulting radiative power of more than 100 mW E.I.R.P. (Effective Isotropic Radiated Power) required the use of an adapted WLAN card operating at a reduced power. In addition to the access points AP3 and AP4 which form the end points of the bridge with analog technology, another access point AP5 for implementing the intermediate infrastructure cell of the hotspot is located at the central location.

The network is cabled with a 100 Mbps switch, with the end points of the bridges (AP3 and AP4) and the center access point (AP5) and the server connected to the switch. The server is implemented using a notebook with a 100 Mbps LAN connection and a Windows™ 2000 operating system.

The computer used as client in the automobile is also provided with Windows™ 2000 and a WLAN card. The signals were amplified with a special 5 dB omnidirectional vehicular antenna.

Investigations Relating to Speed

For investigating the characteristic properties of the connection during travel, both characteristic parameters of the WLAN connection and the data volume were determined, as in the preceding measurements. The initially selected speed was 100 km/m, extending our previous work at speeds of 90 km/h. The mobile client located in a vehicle moved along the highway route at a constant speed.

Investigations of the Connection Quality

The software Network Stumbler (Version v0.3.30) [7] was used for recording exact measurements of the connection quality. Compared to the previously used roam-about client utility, important parameters, such as signal and noise level, and the derived signal-to-noise ratio (SNR) can be recorded much more accurately.

Investigations Relating to Data Transfer Rate

Measurement of characteristic parameters of the wireless network connection does generally not provide any information about the characteristic of a data link. For this reason, software based on the round-trip algorithm was used in the previous measurements, which acquires data via an existing TCP (Transmission Control Protocol) connection. These data are logged and processed. However, it turned out when the data were evaluated that a detailed measurement and the possibility of direct, on-site evaluation, i.e., along the route, would be possible at the measured speed ranges. For this reason, the software NetIQ Chariot (Version v4.3) [8] was used for the new measurements. This software enables script-based control of measurements both for TCP and UDP connections (UDP=Users Datagram Protocol). The version of NetIQ Chariot used in these measurements contained several standard scripts, with the script Throughput.scr being used for measurements of the maximum data throughput. Random data within an exact size of 100,000 Byte were transmitted via both UDP and TCP while the client moved along the route. The data were transmitted in individual packets of maximal 32,767 Byte with TCP, and of maximal 8,183 Byte with UDP (as required by the settings of the employed standard scripts).

All measurements at the various speeds were repeated several times so as to better identify measurement errors. The transmission quality was logged concurrently with the investigations relating to the data throughput.

Investigations Relating to Roaming Performance

The performance of the wireless connection during the roaming phase was identified, on one hand, with the RoamAbout Client Utility (Version v2.69) and, on the other hand, with the already described analytical network tool NetIQ Chariot. Disadvantageously, the client utilities have low resolution and imprecise timing, with the values logged at a rate of approximately 4 values per second. More detailed measurements are possible with NetIQ Chariot. For this purpose, a new script was generated that transmits the required time for transmitting 20 packets, each having a size of 100 byte, via TCP and UDP. This allows inferences above the duration of the roaming phase. The employed software did not permit a reduction in the number of transmitted packets.

Investigations Relating to Voice-Over-IP

The positive results in the preceding- measurements at speeds up to 90 km/h with TCP suggested that investigations directed to a possible use of wireless LAN as a transmission medium for Voice-over IP could also be useful. Two different scenarios were pursued.

In a first scenario, a simulated connection was used which employed NetIQ Chariot and a special Voice-over IP packet to analyze the quality of the transmitted speech. A performance end point was defined on the client within the vehicle for investigating a single voice connection. The high traffic volume during the measurements was taken into consideration by using three speed ranges GB1 to GB3 with the following speed limits:
GB1—from 70 km/h to 100 km/h,
GB2—from 100 km/h to 140 km/h, and
GB3—from 140 km/h to 170 km/h.

The most significant parameters for analyzing the quality of the Voice-over-IP connections are those used for network and voice channel. The transmission rates of the access points were controlled by the access point commensurate with the available signal quality, whereby changes in the transmission rate between 1 Mbps and 11 Mbps are possible. The Voice-over-IP add-on for NetIQ Chariot was initialized with the following parameters:
Employed codec: ITU G.711 A-Law (G.711a)
Frame size per packet: 30 ms
Multimedia transfer protocol: RTP over UDP
No support for Quality of Service (QoS)
De-jitter buffer (ITU recommendation): 60 ms
Initial delay: 0 ms
No transcoding
Total codec-based delay according to ITU G.114:91 ms (including de-jitter buffer, frame size and processing delay)

Three different methods were used for quality checks, which can be subdivided into three phases
Phase 1—without silence suppression and packet loss concealment (PLC)
Phase 2—with silence suppression and PLC, as well as voice activation detection (VAD) rate of 50% (standard value)
Phase 3—with silence suppression and PLC, and other UDP data traffic, the VAD rate is again around 50%. UDP data were simulated by transmitting files of 100,000 Bytes from the server to the client, while the client moved along the route.

In the second scenario, the voice quality was judged subjectively at different speeds using Microsoft NetMeeting. To this end, a real voice connection was set up between a subscriber at the server and a subscriber at the client in the vehicle, whereby the quality of the voice connection could be subjectively checked during the trip. Unlike the first scenario, a variable speed between 90 km/h and 150 km/h was employed.

The codec CCITT A-Law with 8,000 Hz, 8-bit mono-connection used with NetMeeting relates to codec G.711a. No other configurations where used. However, our own measurements indicate that the codec in NetMeeting uses a frame size of 32 ms per packet.

Evaluation of the Measurements

The scenarios presented in the section “A Special Implementation of the Invention and Evaluation Scenarios” were used in the context of a practical measurement for evaluating usability of WLAN in vehicles for communication with stationary stations located on the side of the road. However, when evaluating the results, correlations between the obtained measurement values and external factors along the route must be taken into account. They include, in particular, a high traffic volume which in several situations prevented an actually constant speed, as well as a number of vehicles which formed obstacles in the direct line-of-sight link to the connected access point, thus causing a significant decrease in the signal level (referred to in the literature as Shadow Fading [9]).

Investigations of the Connection Quality

During measurements at speeds between 100 km/h and 170 km/h, no direct proportionality between the speed and the values for the signal and noise level could be detected. The noise level, except for insignificant deviations, is around −100 dB. The single-to-noise ratio (SNR) reached values around 45 dB in close vicinity of the connected access point. The various wireless cells of the hotspots overlap at around 20 dB. FIG. 12 shows the connection quality at an exemplary speed of 100 km/h. Figures representing other speeds are not shown because they do not convey additional information.

Investigations of the Data Transfer Rate

Measurements of the data transfer rate with the network analysis software NetIQ Chariot started at a speed of 100 km/h. These measurements were then repeated for 130 km/h, 150 km/h, and 170 km/h. Because of the high traffic volume, measurements at higher speeds reaching 200 km/h where only temporarily possible and are therefore not explicitly included. The obtained results, however, did not indicate any changes. Table 2 shows the average data throughput at the aforementioned speeds.

TABLE 2
Average data throughput for UDP and TCP at different speeds

| Speed | UDP (Mbps) | TCP (Mbps) |
|---|---|---|
| 100 km/h | 2.8 | 3.3 |
| 130 km/h | 2.6 | 3.1 |
| 150 km/h | 2.5 | 2.7 |
| 170 km/h | 2.6 | 3.0 |

During all the measurements, no interruption of the data connection along the route was detected even at speeds of 170 km/h, indicating that a reliable wireless communication is possible at this speed. As seen in Table 2, the average data transfer rate exhibits only small variations which are not significant enough to make a statement about any dependence on the speed. It is interesting to note that movement alone reduces the data transfer rate by about ¼ to values around 3 Mbps from an average stationary data transfer rate of 4 Mbps. The variations at the different speeds may be caused by the actual conditions along the measurement route and the aforementioned environmental factors. FIG. 13 shows the data transfer rate for both TCP and UDP at a speed of 130 km/h.

Investigations Relating to Roaming

As mentioned above, the duration of a roaming process was determined by sending and receiving 20 packets, each having a size of 100 bytes. The average roaming time can be determined from the difference between the times during a continuous connection and the times during a roaming process. No data can be transmitted while switching between cells. Table 3 shows the average roaming times for TCP and UDP at the different speeds.

TABLE 3
Time differences while roaming

| Speed | UDP (ms) | TCP (ms) |
|---|---|---|
| 100 km/h | 386 | 476 |
| 150 km/h | 423 | 240 |
| 170 km/h | 399 | 265 |
| 190 km/h | 426 | 814 |

The variations between these values allows in principle only a very general statement. While the roaming time for TCP was on the average significantly lower at higher speeds (at approximately 150 km/h) than at lower speeds, it increased threefold at a speed of 190 km/h. Conversely, measurements with UDP did not show these variations. The measurements at other speeds gave similar results, so that it may be necessary in the future to increase the granularity of the measurement series to allow more accurate conclusions. Due to the small size and frequency of the packets, the data transfer rate depicted in FIG. 14 is significantly lower than in the previous investigations. However, the standard deviation about the mean is smaller. Noticeable is the use of an outer access point with an approximately 25% lower data rate, due to the additional integration via wireless link, in contrast to the central access point with a direct, i.e. wired connection.

Investigations Relating to Voice-Over-IP

The investigations to Voice-over-IP were subdivided into two different scenarios. The obtained results in the various scenarios will now be presented:

Simulation of a Voice-Over-IP Connection with NetIQ Chariot

The results from the various tests are shown in Table 4. Because the employed voice channel is asymmetric, the average value of the parameters derived from the individual values for both directions is computed and shown. It should be noted that excellent results were obtained in Test B. In general, the measurement results are similar to those obtained in static WLAN networks. However, the packet loss exceeded the value of 1% stipulated by ITU as a maximum limit, so that the use of PLC at the receiver has to be considered [12] [13]. However, excellent values were determined for the voice quality rate (MOS score >4.0), both in the absence and in the presence of additional high data traffic (Test D). The investigations show that additional data traffic has significant effects only on the time delay, but not on the voice quality and the packet loss. In principle, no effect caused by the speed can be detected on the Voice-over-IP communication, in spite of the poorer results in Test C in comparison to Test B. The reasons for this deterioration may be attributable to effects of the dynamically changing traffic flow on the freeway. Roaming between adjacent WLAN cells also had significant impact on the voice communication in the presence of additional data communication (Test D).

TABLE 4
Investigations relating to Voice-over-IP - Summary of the
measurement values

| | | Test cases | | | |
|---|---|---|---|---|---|
| | | A | B | C | D |
| | | Voice Channel: G711a - Full Duplex | | | |
| | | GB1 + Phase 1 | GB2 + Phase 2 | GB3 + Phase 2 | GB2 + Phase 3 |
| | | Without VAD/PLC | Without VAD/PLC | | VAD/PLC and UDP data |
| Speed in km/h (min-max) | | 70-100 | 100-140 | 140-170 | 100-140 |
| Average data throughput | | 117,208 Kbps | 36,512 Kbps | 35,336 Kbps | 2,244,464 Kbps |
| One-way Delay | | 5 ms | 2 ms | 4 ms | 15 ms |
| End-to-End Delay | | 96 ms | 93 ms | 95 ms | 106 ms |
| Jitter (Delay | Min-max | 0 ms-60 ms | 1 ms-20 ms | 2 ms-42 ms | 9 ms-135 ms |
| Variation) | <11 ms [in 5] | 94 | 96 | 96 | 68 |
| Packet Loss in % | | 1.67 | 1.045 | 1.8 | 1.62 |
| Voice Quality | MOS (mean) | 3.7 | 4.2 | 4.1 | 4.1 |
| | User | Some users not | Satisfied | Satisfied | Satisfied |
| | Satisfaction | satisfied | | | |
| | Quality | Average | High | High | High |
| | Category | | | | |

The various measurement values of the Voice-over-IP parameters shown in Table 4 will be described in more detail below.

Delays

The measurements do not show any correlation between a higher speed and the measured delay values. The delay is greater in Test D due to the additional UDP data traffic, as longer delays are noticeable for waiting queues and serial processing [15]. However, the end-to-end delay remained below the 150 ms recommended by ITU according to G.114 [17]. No effects due to roaming were detected. Interestingly, delays of less than one millisecond were measured in Tests A and B.

Jitter, Propagation Time Variations

The propagation time variations of received packets shown in Table 4 are greater in the tests without VAD, because a greater volume of voice data must be transmitted [13 ] [14]. However, 94% of these variations were below 11 ms, which improved further to 96% in the tests B and C. However, no effects related to speed were detected.

The data traffic increases the propagation time variations, because the delay for waiting queues also increases. The resulting variation in Test D is between 9 ms and 135 ms, which corresponds to approximately twice the jitter buffer and to an end-to-end delay of up to 181 ms. This causes frequent call interruptions and termination of the connection [13 ] [17]. An, albeit small, effect from roaming can also be detected. The propagation time during roaming in Test D varied between 9 and 30 ms, but decreased immediately thereafter. No such effects were observed in other tests.

Data Throughput of the Voice Data

Only pure data without additional protocol overhead (e.g., protocol header) are used in the analysis of voice data. The measurements showed savings in bandwidth through use of silence suppression. The transmitted data volume in Test C was smaller by up to 70% than in Test A. Again, no effects were observed as result of the speed or the roaming behavior. Variations in the data throughput are indistinguishable in the graphic evaluations.

Packet Loss

According to the ITU recommendations, the packet loss cannot exceed the limit of one percent [13]. However, the measurements produced higher values. This effect is directly reflected in the MOS value for the voice quality of only 3.7 in Test A. The use of PLC in the G.711a codec did not produce a significant improvement in spite of a packet loss of 1.8% in Test C. The voice quality improved hereby to an acceptable value of 4.1 (MOS). Roaming had only an insignificant effect on the voice quality. Interestingly, no packet loss was detected in Test D during roaming when traveling from the Eastern access point to the central access point, while a significantly higher value of 3% was measured between the central access point and the Western access point. This resulted in a reduction of the voice quality from 4.37 to 4.1. The packet losses occurred in a burst-like fashion, whereby approximately half the packet losses were attributable to single packets.

Voice Quality

The significant factor in the investigations for Voice-over-IP is the voice quality. The ITU recommendations according to G.114 and G.131 require that a voice communication system has a minimum voice quality of 3.6 expressed in MOS score [17 ] [18]. This average value was reached in all tests, but varied occasionally significantly during the measurements. A range between 2.2 and 4.37 was observed for Test A, whereas excellent values between 4.1 and 4.37 were obtained in Test B.

Subjective Assessment of the Voice Quality Using Microsoft NetMeeting

A positive assessment was obtained by subjectively evaluating the tests with NetMeeting. No communication problems were observed at a speed of 200 km/h. Gaps in the connection were observed only at very large distances (sometimes more than 500 m) to the access points, corresponding to an SNR value of significantly less than 10 dB.

The short interruptions during roaming were not noticeable in the subjective evaluation. The simulated-communication demonstrates the extent of the roaming effect on the transmission.

Summary and Future Prospects

The presented tests of the efficiency of mobile clients in wireless networks based on IEEE 802.11b have demonstrated that data can be transmitted with a high acceptance for wireless usage of different services even when the client travels at a high speed reaching 200 km/h. This applies to data transmissions via both UDP and TCP. The measurements were performed in a test environment under realistic conditions presented by a public freeway accompanied by a high traffic volume. Comprehensive measurements were performed and repeated several times to obtain conclusive results and eliminate errors. A direct effect caused by the speed, physically based on the underlying Doppler effect, could not be ascertained from the measured values. Accordingly, it can be assumed that the WLAN hardware is very adaptive to such frequency variations. On the other hand, the measurement results show that external factors, such as obstacles (for example, trucks) in the direct line-of-sight between access points and client can have a significant effect on the signal level, without causing an interruption in the communication flow. Additional measurements are planned in conjunction with these tests to obtain a better understanding of the process referred to as Shadow Fading.

A direct link between the speed and its effect on the quality of voice transmission (Voice-over-IP) in WLAN systems could also not be established even at speeds reaching 200 km/h. The employed codec, however, should support both PLC and VAD to improve the quality.

Another possibility for implementing roaming for rapidly moving clients involves the use of IEEE 802.16a technology. In addition to the advantages already achieved by using the IEEE 802.11b technology, the use of the IEEE 802.16a technology also allows data transmission with a significantly greater bandwidth.

Behavior of an Access Point with the Roaming Method According to the Invention by Using One of the IEEE 802.16 Technologies New Log-On of a Client System:

At the beginning of a session, a wireless client system (CS) connected, for example, by using the IEEE 802.16a/d/e protocol logs on to any access point (ZP) in the network. Authentication is performed at a central instance (ZI), for example via the RADIUS protocol. The central instance can be a computer located either in the local network or the Internet. During successful log-on, a free private IP address from an address range, which is centrally administered for the locally administered computer network, is transmitted to the access point for use by the client system. This address is assigned to the client system by the access point, using for example the DHCP protocol. The access point also determines the next transition point (UP) to the Internet. These transition points are also referred to as border router. The transition point is assigned to the client system as a standard transition point to the Internet and is sent to the central instance. The access point also informs the transition point to transmit from now on all packets for this private IP address to the access point. The client system communicates from now on via the access point which transmits the packets to the transition point. The reverse direction is configured in a similar manner. The transition point sends the packets for the client system to the access point, which then transmits the packets to the client system. This process does not depend on the version of the employed Internet protocol (IP). For example, transmission can take place with IPv4 (Version 4 of the IP) via the routing option field (Internet RFC 791), with IPv6 (Version 6) by embedding routing information in the IPv6 address, or via the routing extension frame (Internet RFC 2460). Based on the IP address of the target, the transition point decides if the packets are to remain in the internal network or are transmitted to the connected Internet, in which case the packets are sent via the Network Address Translation method (NAT, Internet RFC 3022), where the private IP addresses are translated into public IP addresses.

Change of the Access Point of a Client System:

Roaming describes the method performed by the computer network to enable a transition of a connected mobile client system to another area. The aforementioned roaming solution will now be described:

Log-On at a New Access Point:

During roaming, the client system that is already logged on the local, preferably wireless network, logs on to a new access point. Authentication is performed at a central instance. Similar to a new log-on of a client system (see above), the IP address and the transition point with the Internet of the client system are then transmitted from the central instance to the access point. This information is already stored in the central instance for this purpose and is retrieved. The access point informs the transition point of the client system that all packets should now be sent from now on via this access point.

Log-Off from the Access Point by a Client System:

The old access point of the client system notices that the client system is no longer connected to it and consequently deletes its assignment of the IP address of the client system to the transition point. The central instance is also informed.

Behavior of the Central Instance:

The central instance has an association between the registered client system and the IP address and border router (i.e., transition point). It is also determined if the client system is presently connected to the network. The access points inform the central instance when a client system is connected to them and when the client system leaves the access point. A client system is considered to be connected, if it is logged on. A client system is considered not to be connected, if it does not log on again within a certain time (t_{off}) after having logged off. If a client system is indicated at the central instance as not being connected and is logged on by an access point, then the sender, typically an access point, is informed of the IP address the client system should use and that the access point for the client system must automatically select a border router. If a client system is indicated at the central instance as being connected and is logged on by an access point, then the sender, typically an access point, is informed of the IP address the client system should use and of the border router to which the access point must from now on send all packets of the client system.

FIG. 15 shows a simple configuration of the system with only one wireless cell FZ. The system according to the invention is configured so as to use the wireless technology IEEE 802.16a/d/e. The central transmission station S is hereby attached to a transmitter mast which could be located up to 80 km away from the travel route of the mobile client. The transmitter station advantageously uses a sector antenna, so that the mobile client needs to change its wireless cell relatively infrequently. In a preferred embodiment, a 60° sector antenna is used. The transmitter station also has a direct connection to the ISP and hence also to the Internet. FIG. 15 shows both a mobile client and a stationary client, each of which use the same wireless cell.

FIG. 16 shows a more complex structure of the system. The route is covered by three transmitter stations S1, S2, and S3, wherein the station S1 (shown in the upper left) is the only station connected bidirectionally via a link V1 with the ISP. The station S2 on the right receives data directly from the ISP via satellite SAT by way of a satellite downlink or indirectly via the other stations S1 or S3, for example, via a line-of-sight link RF. However, the station S2 can send its data to the ISP (and therefore to the Internet) only via the indirect link RF. In an alternative embodiment, a direct connection to an ISP could also be provided. As also seen in FIG. 16, the links between the stations can be wired links (e.g., V2 in FIG. 16) or wireless links, whereby the wireless links are preferably implemented with IEEE 802.16a/d/e.

FIG. 17 shows possible wireless coverage inside a tunnel. Depending on the employed technology and the length of the tunnel, a greater or smaller number of transmitter stations (e.g., S4 and S5 in FIG. 17) must be installed. When using the IEEE 802.16a/d/e technology, a single transmitter station, for example S4, installed at an entrance of the tunnel may already be sufficient to provide coverage for the entire tunnel.

In a preferred embodiment, the mobile client is configured as a proxy server to bridge “dead spots” for its subnet and to also offer vehicle-internal value added services. This subnet can include both wired and wireless elements. Preferably, a hotspot employing IEEE 802.16a/d/e technology could be used.

The scope of the invention is not limited to the aforedescribed preferred embodiments. Instead, a number of variations are possible which can include fundamentally different embodiments that are based on the system and methods according to the invention.

### LIST OF REFERENCE CHARACTERS

AP access point
FZ wireless cell
RF line-of-sight link
S, S1, . . . , S5 transmitter station
SAT satellite
V1 bidirectional link between transmitter station and ISP
V2 wired connection between transmitter stations

1. System for roaming in access regions of data and/or communication networks for use with a client moving at a high-speed,
characterized in that
access points (AP) are arranged along the travel route of the client for providing wireless access to data and/or communication networks, for example the Internet, wherein at least one AP is directly connected with the data and/or communication network by a communication link, and
wherein APs without a direct connection to the data and/or communication network are connected by communication links to the APs that have a direct connection to the data and/or communication network.

2. System according to claim 1,
characterized in that
the travel route of the client is covered in its entirety by the illumination areas of the APs (continuous architecture).

3. System according to claim 1,
characterized in that
the travel route of the client is covered partially by the illumination areas of the APs (semi-continuous architecture).

4. System according to claim 1,
characterized in that
the system comprises a computer system for automatically transmitting the data within the data and/or communication network, and that the network-internal computer system for automatically transmitting of the data is configured so that the network-internal computer system for automatically transmitting the data assigns the client an identification, for example an IP address, when the client switches from the area of one AP to the area of another AP (roaming).

5. System according to claim 1,
characterized in that
the data and/or communication network comprises an autonomous, self-administered network, for example a Local Area Network (LAN).

6. System according to claim 1,
characterized in that
the autonomous self-administered network includes one or several transition points to other data and/or communication networks, for example to the Internet.

7. System according to claim 1,
characterized in that
at least one module of the network-internal computer system for automatically transmitting the data is installed on a central server, and at least one module of the computerized system for automatically transmitting the data is installed on at least a portion of the APs, wherein
the module(s) installed on the central server are configured so as to be able to authenticate and administer the client's identification, and
the module(s) installed on the APs are configured so as to be able to perform the association of the transition points.

8. (canceled)

9. (canceled)

10. System according to claim 1,
characterized in that
the system is configured so as to be usable for Voice-over-IP (VoIP).

11. (canceled)

12. Method for roaming in access regions of data and/or communication networks for use with clients moving at a high speed, wherein the data and/or communication network includes access points (AP) for wireless access of data processing devices and/or communication terminals (clients) as well as a computer system for automatically routing the data within the data and/or communication network,
characterized in that
the computer system transmits information about clients to those APs that are located in the travel direction of the client(s).

13. Method according to claim 12,
characterized in that
when the client switches from the area of one AP to the area of another AP (roaming), the network-internal computer system for automatically transmitting the data assigns to the client an identification, for example an IP address.

14. Method according to claim 12,
characterized in that
when the client enters a region of an access point, in particular during roaming, the client is logged on at this access point.

15. Method according to claim 12,
characterized in that
connections that exist on the client remain in existence during roaming and/or the client is always assigned the same identification during roaming.

16. Method according to claim 12,
characterized in that
one of the IEEE 802.11 technologies, for example the IEEE 802.11a, the IEEE 802.11b, or the IEEE 802.11g technology, is used as a technology for wireless transmission of the data.

17. Method according to claim 12,
characterized in that
one of the IEEE 802.16 technologies, for example the IEEE 802.16a, the IEEE 802.16d, or the IEEE 802.16e technology, is used as a technology for wireless transmission of the data.

18. Method according to claim 12,
characterized in that
the method supports use of Voice-over-IP (VoIP).

19. Computer program, which enables a computer, after the computer program is loaded into the memory of the computer, to execute a method for roaming in access regions of data and/or communication networks for use with a client moving at a high speed, wherein the data and/or communication network includes access points (AP) for wireless access of data processing devices and/or communication terminals (clients) as well as a computer system for automatically routing the data within the data and/or communication network, and the method includes the following step:
transmitting information about the clients to APs located in the travel direction of the client(s).

20. Computer program according to claim 19,
characterized in that
the computer program includes several modules, and at least a first module is installed at a central server, and at least a respective second module is installed at the APs.

21. Computer-readable storage medium, which stores a program that enables a computer, after the program is loaded into the memory of the computer, to execute a method for roaming in access regions of data and/or communication networks for use with a client moving at a high speed, wherein the data and/or communication network includes access points (AP) for wireless access of data processing devices and/or communication terminals (clients) as well as a computer system for automatically routing the data within the data and/or communication network, and the method includes the following step:
transmitting information about the clients to APs located in the travel direction of the client(s).

22. Computer-readable storage medium according to claim 19,
characterized in that
the computer-readable storage medium comprises
first modules suitable for installation at a central server and/or
second modules suitable for installation at the APs.

23. Method, wherein a computer program according to one of the following methods:
a) one of the IEEE 802.16 technologies, for example the IEEE 802.16a, the IEEE 802.16d, or the IEEE 802.16e technology, is used as a technology for wireless transmission of the data: or
b) the method supports use of Voice-over-IP (VoIP) is downloaded from an electronic data network, for example, the Internet, to a data processing device connected to the data network.
